(19) United States
(12) Patent Application Publication
(10) Pub. No.: US 2011/0250846 A1
(43) Pub. Date: Oct. 13, 2011

(54) APPARATUS AND ASSOCIATED METHODS

(75) Inventor: Kodo Shu, Kawasaki City (JP)

(73) Assignee: NOKIA CORPORATION, Espoo (FI)

(21) Appl. No.: 12/758,204

(22) Filed: Apr. 12, 2010

(51) Int. Cl. H04B 17/00

(52) U.S. Cl. 455/67.7

(57) ABSTRACT

In one or more embodiments described herein, there is provided an apparatus configured to generate a prioritised radio channel selection list, in accordance with at least one predetermined selection criterion, for one or more adjacent perimeter areas of respective adjacent radio channel cells. The at least one predetermined selection criterion is configured to prioritise radio channels selection in the respective adjacent perimeter areas such that they are ranked to reduce the probability of the same channel being selected for use by radio devices located in the respective adjacent perimeter areas.

The present disclosure relates to the field of licensed/unlicensed wireless communication, in particular, but not necessarily limited to, licensed/unlicensed cellular systems, including unlicensed systems involving white-space devices (also known as WSDs), associated methods, computer programs and apparatus. Certain disclosed aspects/embodiments may relate to portable electronic devices, in particular, so-called hand-portable electronic devices which may be hand-held in use (although they may be placed in a cradle in use). Such hand-portable electronic devices include so-called Personal Digital Assistants (PDAs). In certain embodiments, such portable electronic devices may or may not be mobile cellular devices and/or white space devices.

The portable electronic devices/apparatus discussed in relation to, or according to one or more disclosed aspects/embodiments may provide one or more audio/text/video communication functions (for example, tele-communication, video-communication, and/or text transmission (Short Message Service (SMS)/Multimedia Message Service (MMS)/emailing) functions), interactive/non-interactive viewing functions (for example, web-browsing, navigation, TV/program viewing functions), music recording/playing functions (for example, MP3 or other format and/or (FM/AM) radio broadcast recording/playing), downloading/sending of data functions, image capture function (for example, using a (for example, in-built) digital camera), and gaming functions.

### BACKGROUND

For the purposes of wireless telecommunication, national and international bodies assign frequency bands (or channels) within the radio spectrum for specific uses, and in most cases, license the rights to these channels. Some specific parts of the spectrum may not be used by licensed services in a specific location at a specific time. Local regulatory authorities typically control and authorise the use of such “white-spaces” in their own respective regions, and the available “white-space” bandwidth will therefore vary from country to country.

In the case of the US, on the 4 Nov. 2008, the Federal Communications Commission (FCC) approved the use of vacant/unused portions of the broadcast spectrum in the 54 MHz-698 MHz range by unlicensed devices for fixed and personal/portable use. These vacant/unused portions of the spectrum are known as “white spaces”. These became available for “unlicensed secondary use” after the switchover to digital TV broadcast. The FCC has also defined numerous safeguards in order to protect services and service providers against harmful interference of white-space devices (WSD).

Unlicensed white-space devices must query suitable/appropriate channels available for use before they can operate within such white-space spectrums/bandwidth. This is achieved using databases storing white-space/radio channels available for unlicensed use.

Such databases operate by cross-referencing geographical regions with white-space channels available for use within specific ‘cells’ of that region. For example, a geographical region (such as a country, country state, etc) may be defined as/considered to be made up of a plurality of ‘cells’ (or sub-regions within the overall geographical region). Each of these cells/sub-regions is allocated a specific set of white-space channels that may be usable by WSDs located within that sub-region.

These databases operate on the principle that, if the geographic location of a particular white-space device is known, then the channels available for use by that white-space device can be determined by mapping the geographical location of the white-space device to the corresponding cell stored in the database. As each cell has its own set of radio channels available for use (these stored in the database), the device can be provided with information regarding which channels are available in its particular location.

According to the FCC ruling, all unlicensed white-space devices must access such channel availability databases to determine channels that they are allowed to operate on before they begin white-space transmission or operation. This helps to ensure WSDs operate on channels available for use in their geographical location.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus, the apparatus configured to generate a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

Ranked to reduce probability of the same channel being selected for use by radio devices located in respective adjacent perimeter areas may be understood to involve reducing the likelihood of two or more devices choosing to operate on the same channel, thus causing channel interference. This may also be understood to mean/encompass reducing the probability of channel interference between devices located in particular areas of adjacent areas, and/or thereby avoiding substantial overlap of devices operating on the same channel in adjacent areas, or the like.

The prioritised radio channel selection list may indicate the preferred order in which channels should be selected for use by a device intending to use one or more of these channels in the particular perimeter area. The device, once provided with this information, can select one or more channels to operate on based on the preferred order. This helps to provide a more co-ordinated approach across multiple devices in adjacent cells, rather than arbitrary channel selection.

The device may be located in the perimeter area or in proximity to the perimeter area of a particular cell.

Respective adjacent radio channel cells may each have one or more perimeter areas, and the perimeter areas of each respective cell may each be adjacent to perimeter areas of other adjacent cells. For example, each cell may have a single perimeter area that extends all the way around the boundary of the cell. As another example, each cell may have a plurality of perimeter areas defined at the boundary of the cell and that abut one another, the separation between each perimeter area being defined based on boundaries between further adjacent cells.

The predetermined selection criterion may comprise one or more rules for ranking the radio channel selection in adjacent perimeter areas such that the probability of the same channel being selected for use by radio devices located in adjacent perimeter areas is reduced. For example, these rules may comprise one or more of the following steps:
identification of available radio channels in respective cells, determination of non-common channels and/or common channels in adjacent cells, rank high priority (or preferential) use of available non-common channels in adjacent respective perimeter areas, randomly rank low priority (or non-preferential) use of available common channels across adjacent respective perimeter areas, rank low priority use of available common channels across adjacent respective perimeter areas according to 3, 7 or n-cell-reuse schemes.

Other rules may also provide for channel ranking/prioritisation in the inner/central area such that it is different to the channel listing/order for the perimeter area.

The apparatus may be configured to generate said prioritised channel selection list, in accordance with said at least one predetermined criterion, such that the non-common channels are ranked so as to have a high selection priority in adjacent perimeter areas to thereby increase the probability of different channels being selected for use by radio devices located in the respective adjacent perimeter areas.

The apparatus may be configured to generate said prioritised channel selection list, in accordance with said at least one predetermined criterion, such that the common channels are ranked so as to have a lower selection priority in adjacent perimeter areas relative to the ranking of non-common channels so as to reduce the probability of the same channel being selected for use by radio devices located in the respective adjacent perimeter areas.

The apparatus may be configured to generate said prioritised channel selection list, in accordance with said at least one predetermined criterion, such that the common channels are ranked in opposing/different order in adjacent perimeter areas of respective adjacent cells so as to reduce the probability of the same channel being selected for use by radio devices located in the respective adjacent perimeter areas.

The at least one predetermined criterion may be configured to:
identify available radio channels in respective cells;
determine non-common channels and common channels in adjacent cells; and
rank non-common channels so as to have a high selection priority, and common channels so as to have a lower selection priority relative to the ranking of the non-common channels and in opposing/different order to one another.

Different order may mean ranking channels common across adjacent cells such that the ranking level for a given channel is different for adjacent perimeter areas of adjacent cells, (in other words, the ranking/position in the prioritised list in not the same for a given channel in adjacent cells). This can help to reduce the likelihood that devices in two adjacent respective perimeter areas of adjacent cells select the same channel to operate on within those areas, and thereby also helps to reduce the likelihood of channel interference across adjacent perimeter areas of adjacent cells. Opposing order can mean one channel is ranked first and the other ranked last, or one ranked towards the beginning of the list and the other ranked towards the end of the list.

High selection priority may be understood to mean/encompass that channels are ranked as having a higher priority than other channels (in other words, to be placed nearer the top of the prioritised list). Low selection priority may be understood to mean/encompass that channels are ranked as having a lower priority than other channels (in other words, to be placed nearer the bottom of the prioritised list).

The apparatus may be configured to generate a prioritised radio channel selection list, in accordance with the at least one predetermined selection criterion, for one or more central/inner areas of adjacent radio channel cells, the predetermined selection criterion configured to prioritise radio channels selection in the central/inner areas such that they are ranked to reduce the probability of the same channel being selected for use in a particular time instance by respective devices in the central/inner area and devices in one of the adjacent perimeter areas of that respective cell.

By defining a perimeter area for a given cell, this can also be understood to define an inner or central area closer to the centre of the cell than the perimeter area.

There may also be one or more central/inner areas. Inner and central may encompass areas that are substantially central to the cell, though inner may also encompass areas that are closer to the centre of the cell than the perimeter areas. Some inner areas may be defined between one or more central areas (areas positioned substantially central to the centre of a given cell) and outer perimeter areas. The shapes of the various areas (central, inner, perimeter) may be of any shape, may abut one another (or not), may extend outside a given cell (or not), or the like.

The apparatus may be configured to sub-divide respective adjacent radio channel cells to thereby define one or more perimeter areas and one or more central/inner areas within each cell, the prioritised channel selection lists being generated for each perimeter and central/area so as to reduce the probability of the same channel being selected for use by respective devices in respective adjacent areas during particular time instances.

The apparatus may generate a prioritised channel selection list for one or more areas that is static and does not change over time. The apparatus may also generate a prioritised channel selection list that is updated at set time intervals so that each generated list is generated for a particular time instance (time instance being between updates of the prioritised channel selection list for a given area). The apparatus may also perform this generation of a prioritised channel selection list for a given area only upon a query being made/performed by a device intending to operate within a given area/cell. This list generation may occur prior to a channel availability query by a device, or substantially at the same time as such a query.

The apparatus may be configured to provide the corresponding prioritised radio channel selection list for a particular area/cell to a device in response to the device querying radio channel selection availability whilst the device is located substantially in the cell.

Located substantially within a cell may encompass a device actually being within a cell, being in proximity to cell, about to enter a particular cell or exit from one cell into another cell for which channel availability has been queried/about to be queried, or the like.

Said criterion may each comprise one or more rules. These criterion or rules may govern preferred channel selection order for a mobile radio device located in a given perimeter area, for communication within respective perimeter areas to thereby reduce the probability of channel interference between devices located in particular areas of adjacent cells.

The criterion/rules may govern preferred channel selection order for a mobile radio device located in a given area, for communication within each area to thereby reduce the probability of channel interference between devices located in particular areas of adjacent areas.

The criterion/rules may govern preferred channel selection order for a mobile radio device located in a particular area to thereby avoid substantial overlap of devices operating on the same channel in adjacent areas.

One or more of the criterion/rules may be respectively weighted to give particular preference to said one or more rules over the other rules. Heavier weighted rules may therefore serve as a greater determining factor than lighter weighted rules.

In another aspect, there is provided an apparatus. This apparatus may have the same features as the apparatus of the first aspect, and may be selected from a list comprising:
a network database server, a cellular network database server, a white-space network database server, a mobile/portable radio device, a hand-portable radio device, or a module for the aforementioned server/device.

The apparatus may be provided as part of any of the aforementioned servers/devices, or may just be electrically/wirelessly/directly/indirectly connected to these, or may be provided separately, or may even have performed said generation of prioritised channel selection list separately and is not actually used with servers/devices responding to channel availability queries.

In another aspect, there is provided an apparatus comprising a generator/means for generating configured to generate a prioritised radio channel selection list, in accordance with at least one predetermined selection criterion, for one or more adjacent perimeter areas of adjacent radio channel cells, the predetermined selection criterion configured to prioritise radio channels selection in adjacent perimeter areas such that they are ranked to reduce the probability of the same channel being selected for use by radio devices located in adjacent perimeter areas.

In another aspect, there is provided a computer readable medium comprising a computer program stored thereon, the computer program comprising program code configured to, when run on a processor, generate a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

In another aspect, there is provided a module configured to generate a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

In another aspect, there is provided a method comprising generating a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

In another aspect, there is provided an apparatus, the apparatus comprising means for generating a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

In another aspect there is provided a radio device comprising the apparatus of the first aspect, wherein the device is configured to:
receive non-prioritised channel selection signalling indicating a non-prioritised channel selection list;
receive indication signalling indicative of the at least one predetermined selection criterion; and
prioritise the non-prioritised channel selection list using the predetermined selection criterion to thereby generate the prioritised radio channel selection list.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:—

FIG. 1 illustrates an apparatus of a first embodiment.

FIG. 2 illustrates the principle of operation of an embodiment of the present disclosure.

FIG. 3 illustrates an example of predetermined criterion governing prioritisation of channel selection order.

FIG. 4 illustrates a flowchart of method of operation of an embodiment of the present disclosure.

FIG. 5 illustrates schematically a computer readable media providing a program according to an embodiment of the present invention.

### DESCRIPTION OF EXAMPLE ASPECTS/EMBODIMENTS

In one or more embodiments described herein, there is provided an apparatus configured to generate a prioritised radio channel selection list, in accordance with at least one predetermined selection criterion, for one or more adjacent perimeter areas of respective adjacent radio channel cells. The at least one predetermined selection criterion is configured to prioritise radio channels selection in the respective adjacent perimeter areas such that they are ranked to reduce the probability of the same channel being selected for use by radio devices located in the respective adjacent perimeter areas.

By ranking the available channels in a particular way, devices requesting information as to which channel they can operate on (for example, white-space devices as discussed in the background section) can be provided with prioritised listing that indicates which channels are to be selected first (if possible). It is therefore possible to, via such prioritised lists, direct devices in a given area towards one channel whilst directing devices in another adjacent area to a different channel. This can help to reduce the probability of two devices trying to operate on the same channel within the same area/cell as one another, thus reducing the probability of channel interference between such devices.

As discussed in the background, white-space communication has presently been opened up in relation to unlicensed operation in the television frequency bands. It will be appreciated that at least some of the embodiments describe herein are not limited to use in just this area, and that the present disclosure may be utilised across unlicensed or licensed frequency bands (fixed or otherwise) other than such television frequency bands (for example, across licensed cellular network frequencies provided that co-existence is possible—such as ISM frequency band). For example, IEEE 802.19.1 standardization may alleviate/address the possibility of secondary use over already licensed channels, i.e. allowing co-existence of unlicensed devices on already licensed channels.

The current concept of white-space communication can be understood as “secondary use” of licensed/unlicensed frequency bands. Secondary use can also be understood to encompass any devices that operate as a “secondary user” of an existing frequency allocation.

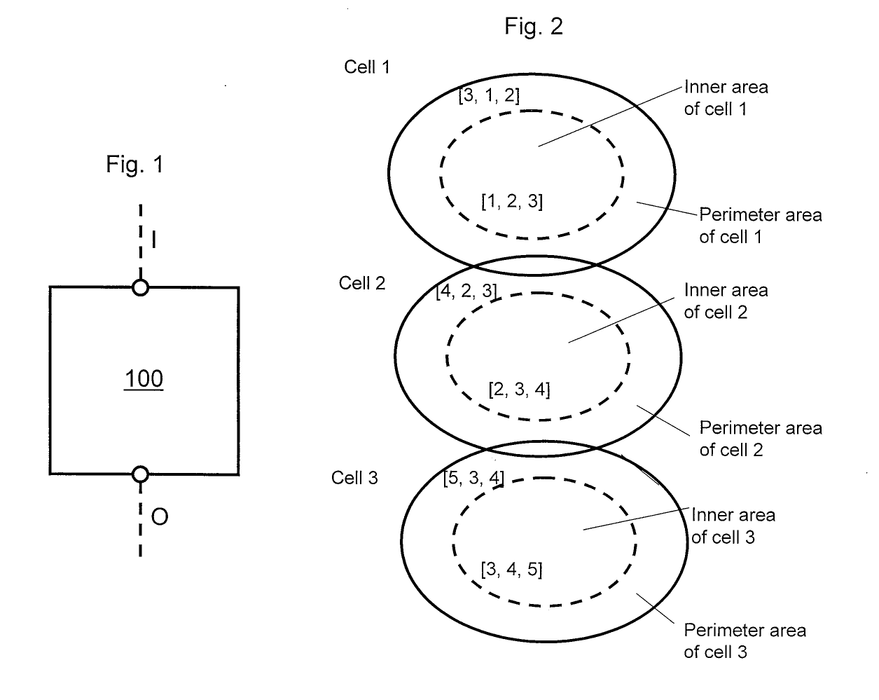

We will now describe an apparatus 100 according to a first embodiment with reference to FIG. 1.

FIG. 1 illustrates an apparatus 100. In this embodiment the apparatus is a processor, in particular an Application Specific Integrated Circuit (ASIC) processor. In particular, this processor 100 is part of a server (such as a network database server, cellular network server, or the like) or related electronic device that can provide channel availability information to white-space devices querying this information. In other embodiments the processor/apparatus 100 may be provided separately from the aforementioned server, in an electronic device, or the like.

The apparatus 100 can be connected to an input (I) and an output (O) formed via a connection bus (or the like). The input allows for receiving signalling, and the output allows the apparatus to provide an output (for example, via further signalling).

The processor/apparatus 100 is internally formed from different functional blocks (not shown). These functional blocks help the processor/apparatus 100 to be able to generate a prioritised radio channel selection list, based on at least one predetermined selection criterion, for one or more adjacent perimeter areas of respective adjacent radio channel cells.

In this embodiment the processor 100 comprises a processing block 110 (not shown) and a memory block 120 (not shown). The processing block 110 is able to operate on signalling received via the input so as to provide an output (via the output of the connection bus). The memory block 120 is for storing a set of criteria for analysing and operating on the signalling. In this embodiment, each criterion comprises one or more rules. Each criterion sets out a particular goal to satisfy (for example, identify channels available within a particular area/cell) that are implemented functionally by the one or more rules.

The functional blocks 110, 120 are electrically interconnected within the processor 100 (and to the connected/connectable input and output of the connection bus) to allow the processing block 110 to access the rules/criteria stored on the memory block 120, and to operate on received signalling based on these criteria. In other embodiments, the memory block 120 can be provided separately from the processor 100, and the processor 100 can access the memory block 120 via the connection bus (or even a separate connection—not shown).

The formation of such processors and integration within electronic devices, and the design of such processors to achieve application specific objectives is well known and would be well appreciated by the skilled person based on the above discussion. We will therefore not discuss these aspects.

The criteria and rules stored on the memory block 120 set out at least one scheme that governs how the processing block 110/processor 100 as a whole operates on and analyses the signalling. For clarity in describing an example of criteria in such a scheme, we will now describe how this apparatus 100 can be used in an example scenario with reference to FIG. 2.

As discussed above, in this embodiment the processor 100 is able to use the criteria stored on the memory block 120 to generate a prioritised radio channel selection list for perimeter areas of respective adjacent radio channel cells, and the processor 100 is also electrically connected to a white-space database (via the connection bus to a network database server). The processor can therefore access the white-space database which contains cross-referenced information regarding white-space cells and the channels available within each.

An illustration of three adjacent cells with their respective perimeter areas are illustrated in FIG. 2. In this example, the cells of the database are not already sub-divided to have a perimeter area (although in some embodiments this may be the case). The processor 100 therefore treats the predefined cells stored on the database as if they were sub-divided into one or more perimeter areas. In essence the processor 100 operates such that it defines a perimeter area for each cell and operates on the respective cells as if they each had such a perimeter area. In other embodiments the processor may actually modify the database to cause the respective cells to be sub-divided to each have one or more respective perimeter areas. These areas may be referred to as sub-regions, zones, sub-areas, or the like.

For this example, each cell is treated as if it were composed of an outer area/zone that we refer to as a ‘perimeter area’. A by-product of this is that an inner area is defined within the cell. This can be understood as a ‘central area’ or ‘inner area’. In this example, we have illustrated just one perimeter area that is a margin or boundary around the edge of the cell, and just one inner/central area that is positioned to be central to the cell. The skilled person will appreciate that the cells can be divided into one or more perimeter areas and/or one or more inner/central areas depending on the configuration or needs of the system. In some embodiments the processor 100 may actually sub-divide the cells into such areas.

The perimeter areas serve to define areas of the cell that are like a margin or ‘buffer zone’ that mark out/denote a space where a devices transmissions may be detectable/receivable by another device in a respective adjacent perimeter area of an adjacent cell. For example, if a device is in the perimeter area of cell 1 of FIG. 2, then any white-space wireless transmissions the device makes may be detectable/receivable by devices operating in a similar vicinity proximity but within the perimeter area of cell 2. Even though these devices are in different cells, same-channel interference due to actual proximity of the devices to one another may still occur. Therefore, it is helpful to try and reduce the likelihood of two or more devices operating on the same channel across adjacent respective cells and in close proximity to one another. The present embodiment discussed in this example helps to alleviate this issue.

The areas may be defined by a heuristic rule. For example, the central/inner area defined as a by-product of the perimeter area can be roughly two thirds the size of the whole area. Another option is to pre-calculate the interference level from a given WSD in the perimeter area of a given cell to the inner/central area of a neighboring/adjacent area/cell, based on certain criteria of maximum allowable/permissible interference (which may be dependent on nature of communication to be performed, or location communication is to be performed in, or the like), and from this maximum allowable interference determine the area separation needed for the respective areas.

To provide the prioritised channel selection list for a given perimeter area, the processor 100 refers to the criteria/rules stored on the memory block as to how to operate on the cells and channel information provided by the database, and to then generate the prioritised list for the perimeter areas based on these criteria.

In this embodiment, the criteria/rules cause the processor to check the following:
1) Identify channels available across respective cells;
2) Determine the non-common channels across respective adjacent cells and also the common channels across respective adjacent cells; and
3) Rank the non-common channels between respective adjacent perimeter areas of respective adjacent cells so as to have a high selection priority and rank the common channels between respective adjacent perimeter areas of respective adjacent cells so as to have a low selection priority and in opposing order.

The first stage establishes exactly which channels are available for use in respective cells. As illustrated in the example of FIG. 2, cell 1 has channels [1, 2, 3] available for use, cell 2 has channels [2, 3, 4] available for use, and cell 3 has channels [3, 4, 5] available for use (indicated within the inner/central area). This information is stored within the white-space database server, and is accessed by the processor 100 via the connection bus based on criteria instructions on the memory block 120. At this stage the available channels have been identified but not prioritised or ranked.

The second stage is used to compare the available channels in adjacent respective cells to determine channels that are common across such adjacent cells, and also to determine those that are not common (i.e. non-common) across such adjacent cells. The processing block 120/processor 100 as a whole compares channels available in immediately adjacent cells (although in some embodiments the processor 100 may compare channels from cells within a certain range of a given cell). As a result of this stage, there will be two lists of channels (common list and non-common list) for each pair of adjacent cells. For example, in FIG. 2, there will be a common channel list and non-common channel list for the adjacent cell pair 1 & 2, and similarly for adjacent cell pair 2 & 3. At this stage, available channels have been identified but not prioritised/ranked (although this stage could be considered to encompass a ‘preliminary sorting’ of the channels).

The third stage is used to co-ordinate and correlate the information regarding the non-common channels and common channels across the respective adjacent cells to provide a cohesive/coherent prioritised list of channels for adjacent respective perimeter areas of adjacent respective cells. This involves ranking the channels in each perimeter area so as to optimise preferred channel selection order. We will now describe how this is achieved in this particular example scheme.

This scheme addresses the non-common channels between adjacent cells first. Where two particular adjacent cells have channels that are not common across each other, it can be optimal to prioritise these respective differing channels within each cell as a high priority for selection by a device, at least when such a device is positioned such that it is in close proximity to another cell (this being marked out/denoted by the respective perimeter areas of each cell).

For example, FIG. 2 shows that cell 1 and cell 2 have non-common channels of [1] and [4] (i.e. cell 1 has channel [1] whilst cell 2 does not, and cell 2 has channel [4] whilst cell 1 does not). When an unlicensed device is close to the boundary between these areas, or even in an overlapping region (as shown in FIG. 2), it can be optimal to ensure that the device is operating on a channel that is not shared by the neighboring cell. This helps to avoid the situation where two devices in different neighboring/adjacent cells are operating on the same channel and experiencing channel cross-talk or interference with one another (see cell 1 and cell 2 of FIG. 2).

Therefore, the third stage can be understood to encompass ranking of channels that are not common across neighboring/adjacent cells as high priority order in perimeter areas. This means that non-common channels are nearer the top of the prioritised list (for devices in respective perimeter areas that receive this prioritised list). In this example, this would direct respective devices in adjacent perimeter areas of cell 1 and 2 to operate on channel [1] in cell 1, and channel [4] in cell 2 respectively. As these respective channels are not common across adjacent cells 1 and 2, then the probability of two such devices located in respective adjacent cell perimeter areas operating on the same channel is reduced, and therefore the probability of same-channel interference/cross-talk is also reduced.

After non-common channels have been addressed, the scheme looks at how to rank the common channels, although the skilled person will appreciate that either could be considered first, or they could even be considered simultaneously or separately. Where two particular adjacent cells have channels that are common across each other, it can be optimal to prioritise these respective differing channels within each cell as a low priority, at least when a device is close to entering another cell, and also in opposing order to one another.

For example, FIG. 2 shows that cell 1 and cell 2 have common channels of [2, 3] (i.e. cells 1 and 2 both have channels [2, 3] available for use by devices within those cells. When an unlicensed device is close to the boundary between these areas, or even in an overlapping region (as shown in FIG. 2), it can be optimal to ensure that the device is operating on a channel that is not shared by the neighboring cell. For common channels, it can be optimal to rank channels common across adjacent cells as low priority (at least relative to non-common channels). This helps to avoid the situation where two devices in different neighboring/adjacent cells are operating on the same channel and interfering with one another (see cell 1 and cell 2 of FIG. 2).

In order to reduce the likelihood that devices still select the same channel for use, even when they are given low priorities, the common channels are given opposing/different order in different cells such that their respective numerical ranking (for example, 1st, 2nd, 3rd, etc) is not the same in each cell. For the example in FIG. 2, the order in cell 1 is [3, 1, 2] and the order in cell 2 is [4, 2, 3]. In other words, the common channels between cell 1 and cell 2 are ranked after the non-common channels, and they are ranked in reverse/opposing/different order to one another. The second preferred choice in each case in ranked in a different order such that the probability of the same channel being selected by a device in perimeter areas of respective adjacent cells is reduced.

Therefore, the third stage can be understood to encompass ranking of these common channels to give them a low selection priority and so as to be in opposing order. In essence, the third stage acts on the information regarding the common/non-common channels determined by the second stage, and uses this information to rank the channels in a prioritised and preferred selection order to reduce and/or optimise the selection list provided to devices in those respective areas. This provides a co-ordinated approach to help devices querying channel availability information to prioritise selection channels to reduce the likelihood that two devices in adjacent perimeter areas (where interference across neighboring cells is more likely) select the same channel for white-space communication/transmission.

We have described these rules with reference to just two adjacent areas/cells. The above scheme can be generalised to a plurality of adjacent cells across a whole geographical region or network. FIG. 2 also illustrates a third cell and the same principle of operation has been applied here to provide for reduced likelihood of the same channel being selected for use across perimeter areas of adjacent cells.

A further variation of this embodiment can also be drawn from FIG. 2. As discussed above, a by-product of defining perimeter areas in that central/inner areas are also defined (as shown in FIG. 2). Whilst the likelihood of channel interference between adjacent cells is highest when devices are operating near the boundaries of their respective cells and therefore within proximity of devices in different neighboring cells, further optimisation can also be achieved by prioritising channel selection orders/lists within the central/inner areas as well as in the perimeter areas. In a simple embodiment, the channels in the central area can be determined after the perimeter area, ranking these in opposing order to the prioritised list for the perimeter area of that cell to further reduce the probability of channel interference across respective areas (i.e. between devices in the perimeter area and devices in the inner/central area of the same cell). In another embodiment, the channels in the central area are determined and ranked first according to the same/similar rules/criteria discussed above, and the channel ranking for the respective perimeter areas are calculated after this (for example, in opposing order to the channel ranking for the respective inner/central areas).

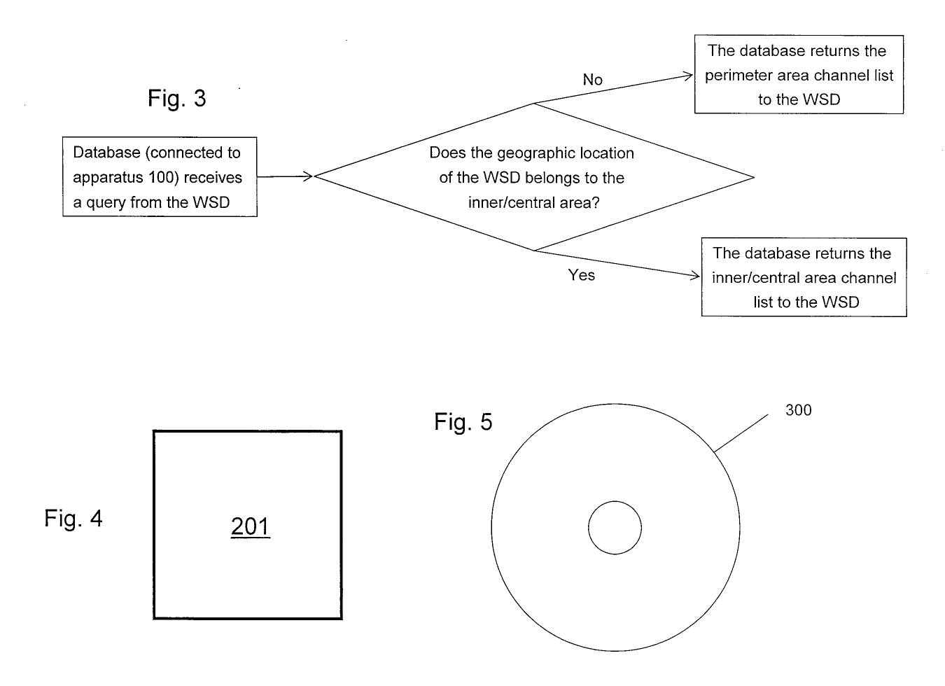

In such a variation, it is helpful to know the geographical location of a particular device and whether it lies in an inner/central area/zone or an outer/perimeter area/zone. FIG. 3 illustrates a flowchart method of how this can be performed in the context of the present embodiment. It would be well appreciated by the skilled person how to implement such a method workflow in embodiments according to the present disclosure.

Discussed above is just one scheme outlining criteria and rules for generating a prioritised channel selection list for a perimeter area of a cell. This scheme can be understood to encompass (at least in some embodiments) principles of soft-frequency re-use and dynamic channel allocation, as well as co-ordination of channel allocation between cells/areas. Other schemes are also within the scope of the present disclosure . . . .

For example, the principles described above can be generalised to situations where there are any number of neighboring/adjacent cells (for example, 3, 4, 5, 6, 7 or even more cells). There can be other rules that reutilise the channel re-use principles described above. Other embodiments may also use rules that generate a partially random channel listing after initial ranking (based on rules/criteria) to ensure that the probability of channel overlap between adjacent cells/areas is reduced (for example, for common channels in a region with a dense clustering of cells).

In the present embodiment, it can be seen that there are two sets of rules/criteria: one set for governing non-common channels; and one set for governing common channels.

There may be one or more other rule/criteria sets for governing the relative ranking of non-common channels to common channels. In at least this example, the ranking of the non-common channels is more important than the ranking of the common channels (particularly for perimeter areas, the rules/criteria governing non-common channels is more important than those governing the common channels). Therefore, more weight is given to the rules/criteria governing the non-common channels than those governing the common channels. Other variations may utilise different weightings to the different rules to prioritise one set of rules/criteria over others, and different weightings may be applied for rules/criteria in different areas and/or cells.

For example, a further scheme may follow another set of rules for allocating common or non-common channels across areas of cells. For example, if only common channels are available between the adjacent perimeter areas, then a random selection/ordering may be applied, or cell-reuse principles (such as 3 cell-reuse or 7 cell-reuse, or the like) can be applied. Such ‘cell reuse’ principles are well understood in the art and will not be discussed further.

In some situations, the channel identified as highest priority may be identified as such to white-space devices, whilst the priority of lower priority channels may not be communicated to white-space devices. Alternatively, the top 2/3/4/5 etc priority channels may be identified as such to the white-space devices instead. This can still allow for reducing the likelihood of the same channel being selected for use across two adjacent areas of adjacent cells, whilst also reducing the computational complexity of communicating the ranking/priority of all available channels to a given white-space device (as in some situations there may be a compromise between these two aspects).

In one further embodiment, the generation of the prioritised channel selection list may be performed by the radio device operating in a given area. For example, the device can be configured to receive non-prioritised channel selection signalling that indicates available channels in a non-prioritised channel selection list (i.e. channels available as indicated by a white-space database). The device can also receive indication signalling indicative of the at least one predetermined selection criterion as discussed above. The device can then prioritise the non-prioritised channel selection list using the predetermined selection criterion to thereby generate the prioritised radio channel selection list discussed above. Other variations of this are also within the scope of the present disclosure.

The embodiments and variations described above allow for a number of advantages over what is presently known. For example, white-space devices (at present) receive channel information without any weighting, ranking, and sometimes without even any choice (a database may arbitrarily allocate a channel to a device with little or no consideration given to why—some systems give consideration to channel quality in a given cell before responding to channel availability queries). The process by which channel information is provided, and also by which channel selection is made, is somewhat arbitrary at both server and device end of present arrangements, and ultimately provides this information on an individual device basis. There is co-ordination between providing appropriate channel selection information to different devices in different cells. In contrast, by prioritising channel selection order in the manner discussed above, it is possible to reduce the arbitrariness of the channel selection and/or provision of channel information to different white-space devices. In essence, the embodiments described herein provide for a co-ordinated approach for devices across different respective cells to enhance device operation on a local device scale and also a cross-network scale.

FIG. 4 illustrates a method of operation according to another embodiment of the present disclosure. The method comprises:
201—generating a prioritised radio channel selection list, in accordance with at least one predetermined selection criterion, for one or more adjacent perimeter areas of respective adjacent radio channel cells. As discussed above, the predetermined selection criterion are configured to prioritise radio channel selection in the respective adjacent perimeter areas such that they are ranked to reduce the probability of the same channel being selected for use by radio devices located in the respective adjacent perimeter areas.

This method of operation (as well as variations thereof) has been discussed at length above, and will not be discussed further.

FIG. 5 illustrates schematically a computer/processor readable media 300 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device/server and/or other features of particular mentioned apparatus/device/server may be provided by apparatus arranged such that they become configured to carry out the desired operations only when enabled, for example, switched on, or the like. In such cases, they may not necessarily have the appropriate software loaded into the active memory in the non-enabled (for example, switched off state) and only load the appropriate software in the enabled (for example, on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (for example, memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (for example, including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising at least one processor, and at least one memory including computer program code, the at least one memory and the computer program code configured to, with the at least one processor, cause the apparatus to generate a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

2. The apparatus as claimed in claim 1, wherein the at least one memory and the computer program code are configured with the at least one processor to cause the apparatus to generate said prioritised channel selection list, in accordance with said at least one predetermined criterion, such that the non-common channels are ranked so as to have a high selection priority in adjacent perimeter areas so as to increase the probability of different channels being selected for use by radio devices located in the respective adjacent perimeter areas.

3. The apparatus as claimed in claim 1, wherein the at least one memory and the computer program code are configured with the at least one processor to cause the apparatus to generate said prioritised channel selection list, in accordance with said at least one predetermined criterion, such that the common channels are ranked so as to have a lower selection priority in adjacent perimeter areas relative to the ranking of non-common channels so as to reduce the probability of the same channel being selected for use by radio devices located in the respective adjacent perimeter areas.

4. The apparatus as claimed in claim 1, wherein the at least one memory and the computer program code are configured with the at least one processor to cause the apparatus to generate said prioritised channel selection list, in accordance with said at least one predetermined criterion, such that the common channels are ranked in opposing/different order in adjacent perimeter areas of respective adjacent cells so as to reduce the probability of the same channel being selected for use by radio devices located in the respective adjacent perimeter areas.

5. The apparatus as claimed in claim 1, wherein the at least one predetermined criterion is configured to:
identify available radio channels in respective cells;
determine non-common channels and common channels in adjacent cells; and
rank non-common channels so as to have a high selection priority, and common channels so as to have a lower selection priority relative to the ranking of the non-common channels and in opposing/different order to one another.

6. The apparatus as claimed in claim 1, wherein the at least one memory and the computer program code are configured with the at least one processor to cause the apparatus to generate a prioritised radio channel selection list, in accordance with the at least one predetermined selection criterion, for one or more central/inner areas of adjacent radio channel cells, the predetermined selection criterion configured to prioritise radio channels selection in the central/inner areas such that they are ranked to reduce the probability of the same channel being selected for use in a particular time instance by respective devices in the central/inner area and devices in one of the adjacent perimeter areas of that respective cell.

7. The apparatus as claimed in claim 6, wherein the at least one memory and the computer program code are configured with the at least one processor to cause the apparatus to sub-divide respective adjacent radio channel cells to thereby define one or more perimeter areas and one or more central/inner areas within each cell, the prioritised channel selection lists being generated for each perimeter and central/area so as to reduce the probability of the same channel being selected for use by respective devices in respective adjacent areas during particular time instances.

8. The apparatus as claimed in claim 1, wherein the at least one memory and the computer program code are configured with the at least one processor to cause the apparatus to provide the corresponding prioritised radio channel selection list for a particular area/cell to a device in response to the device querying radio channel selection availability whilst the device is located substantially in the cell.

9. The apparatus as claimed in claim 1, wherein said rules govern preferred channel selection order for a mobile radio device located in a given perimeter area, for communication within each perimeter area to thereby reduce the probability of channel interference between devices located in particular areas of adjacent cells.

10. The apparatus of claim 1, wherein the apparatus further comprise an apparatus selected from a list comprising: a network database server, a cellular network database server, a white-space network database server, a mobile/portable radio device, a hand-portable radio device, or a module for the aforementioned server/device.

11. An apparatus comprising a generator configured to generate a prioritised radio channel selection list, in accordance with at least one predetermined selection criterion, for one or more adjacent perimeter areas of adjacent radio channel cells, the predetermined selection criterion configured to prioritise radio channels selection in adjacent perimeter areas such that they are ranked to reduce the probability of the same channel being selected for use by radio devices located in adjacent perimeter areas.

12. A computer program product comprising a computer readable medium having a computer program stored thereon, the computer program comprising program code configured to, when run on a processor, generate a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

13. An apparatus comprising a module configured to generate a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

14. A method comprising generating a prioritised radio channel selection list, in accordance with at least one predetermined selection criterion, for one or more adjacent perimeter areas of respective adjacent radio channel cells, the predetermined selection criterion configured to prioritise radio channels selection in the respective adjacent perimeter areas such that they are ranked to reduce the probability of the same channel being selected for use by radio devices located in the respective adjacent perimeter areas.

15. The method according to claim 14, further comprising generating said prioritised channel selection list, in accordance with said at least one predetermined criterion, such that the non-common channels are ranked so as to have a high selection priority in adjacent perimeter areas so as to increase the probability of different channels being selected for use by radio devices located in the respective adjacent perimeter areas.

16. The method according to claim 14, further comprising generating said prioritised channel selection list, in accordance with said at least one predetermined criterion, such that the common channels are ranked so as to have a lower selection priority in adjacent perimeter areas relative to the ranking of non-common channels so as to reduce the probability of the same channel being selected for use by radio devices located in the respective adjacent perimeter areas.

17. The method according to claim 14, further comprising generating said prioritised channel selection list, in accordance with said at least one predetermined criterion, such that the common channels are ranked in opposing/different order in adjacent perimeter areas of respective adjacent cells so as to reduce the probability of the same channel being selected for use by radio devices located in the respective adjacent perimeter areas.

18. The method according to claim 14, further comprising generating a prioritised radio channel selection list, in accordance with the at least one predetermined selection criterion, for one or more central/inner areas of adjacent radio channel cells, the predetermined selection criterion configured to prioritise radio channels selection in the central/inner areas such that they are ranked to reduce the probability of the same channel being selected for use in a particular time instance by respective devices in the central/inner area and devices in one of the adjacent perimeter areas of that respective cell.

19. The method according to claim 18, further comprising subdividing respective adjacent radio channel cells to thereby define one or more perimeter areas and one or more central/inner areas within each cell, the prioritised channel selection lists being generated for each perimeter and central/area so as to reduce the probability of the same channel being selected for use by respective devices in respective adjacent areas during particular time instances.

20. A radio device comprising the apparatus of claim 1, wherein the device is configured to:
receive non-prioritised channel selection signalling indicating a non-prioritised channel selection list;
receive indication signalling indicative of the at least one predetermined selection criterion; and
prioritise the non-prioritised channel selection list using the predetermined selection criterion to thereby generate the prioritised radio channel selection list.
